(19) United States
(12) Patent Application Publication
(10) Pub. No.: US 2007/0299718 A1
(43) Pub. Date: Dec. 27, 2007

(54) Management activity tracking utility

(75) Inventors: Joe H. Williams, Columbia, TN (US); Felix Ammay, Kings Mountain, NC (US); Aaron D. Harrell, Charlotte, NC (US); Jackie E. Walker, Charlotte, NC (US); Kathryn W. Childs, Concord, NC (US)

Correspondence Address: MERCHANT & GOULD BELLSOUTH CORPORATION, P.O. BOX 2903, MINNEAPOLIS, MN, 55402, US

(73) Assignee: BellSouth Intellectual Property Corporation

(21) Appl. No.: 11/474,828

(22) Filed: Jun. 26, 2006

(51) Int. Cl. G06F 11/34

(52) U.S. Cl. 705/11

(57) ABSTRACT

An activity tracking utility receives work activity information such as category and description of work performed, time spent, exceptions, and the like from a person performing the work or from a manager supervising the person. The utility prepares and provides reports based on collected data in real time or accrued modes to managers of various levels, other applications configured to consume the report data, and the like. Administrative changes may be performed setting parameters associated with tracking the activities. Permission levels for providing input and/or receiving reports may be set based on user credentials.

### TECHNICAL FIELD

Embodiments are related to tracking work activities. More particularly, the disclosed subject matter is related to computer-implemented methods, configurations, systems, and computer program products for facilitating tracking of work activities, exceptions, and lost time by supervising and non-supervising managers in a hierarchically structured organization.

### BACKGROUND

For many organizations, the purpose of the job performance evaluation system is to promote employee development, to enhance employee productivity, to serve as a basis for sound personnel decisions, and to provide a permanent record of the performance of major job duties and responsibilities for employees within the organization.

While tracking and measuring performance of employees that perform objectively measurable tasks, such as assembly of products, may be relatively simple, many employees perform tasks that do not necessarily fall into a single category or can be measured in a simplistic way. To complicate the task of job performance management, multiple layers of hierarchical structures may exist in an organization with employees in various supervisory relationships. The subjectivity and hierarchical complexity of many employees' job definitions makes it difficult to track and maintain a real time performance review for those employees.

### SUMMARY

Consistent with embodiments described herein, systems and methods are disclosed for tracking work activities in an organization using computer systems. Key features or essential features of the claimed subject matter are not necessarily identified in this summary portion.

Embodiments are directed to tracking activities in an organization based on receiving activity information from reporting members or their managers within the organization. Reports based on tracked activities may be prepared on demand, periodically, or in an accrued manner. Reports may be at individual level, at group level, or at any combination of organizational members. Report types may include any presentation of collected information, raw data, or formatted data to be consumed by other applications. Permission levels and/or user credentials may be used to restrict access for providing input or receiving reports.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

FIG. 1 is a block diagram of an example computing operating environment;

FIG. 2 illustrates a system where example embodiments may be implemented;

FIG. 3 illustrates a conceptual diagram of interactions between components of an activity tracking system according to embodiments;

FIG. 4 illustrates a conceptual diagram of how an activity tracking system can be used according to one scenario;

FIG. 5 illustrates a conceptual diagram of how an activity tracking system can be used according to another scenario; and

FIG. 6 illustrates a logic flow diagram for a process of work activities according to one embodiment.

### DETAILED DESCRIPTION

As briefly described above, a management activity tracking utility may be provided to track work activities, exceptions, and lost time by supervising and non-supervising managers. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

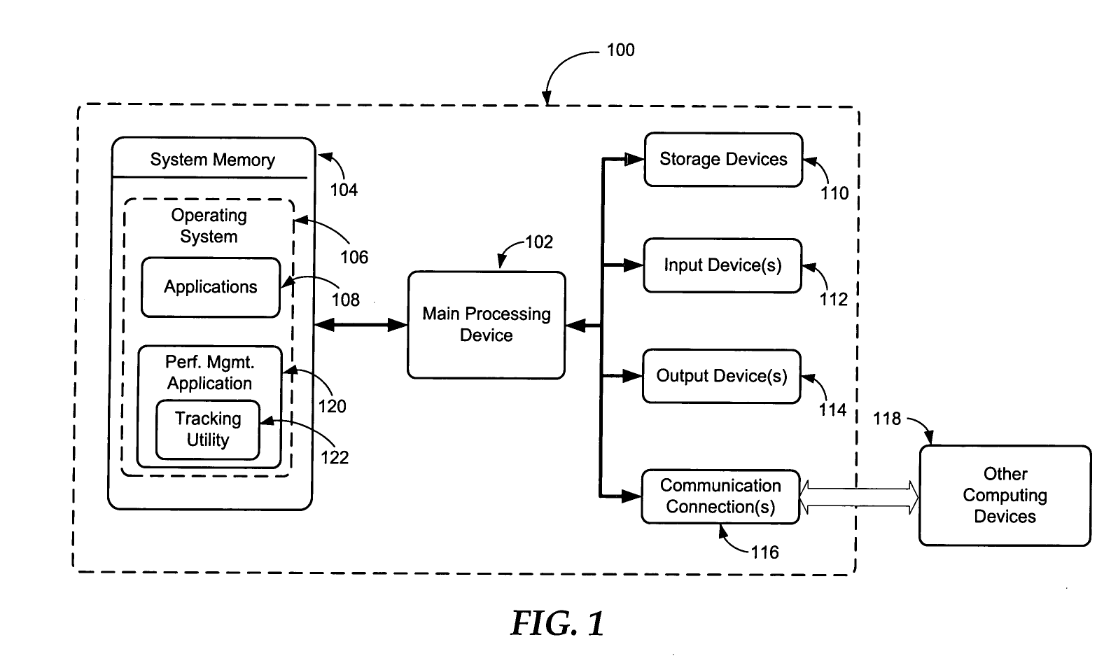

Referring now to the drawings, aspects and an exemplary operating environment will be described. FIG. 1 and the following discussion are intended to provide a brief, general description of a suitable computing environment in which the invention may be implemented. While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

With reference to FIG. 1, one example system for implementing the embodiments includes a computing device, such as computing device 100. Computing device 100 typically includes a main processing unit 102 and system memory 104. The system memory 104 may be volatile (such as RAM), non-volatile (such as ROM, flash memory, etc.) or some combination of the two. System memory 104 typically provides an environment for an operating system 106 to be executed for controlling the operation of computing device 100 and execution of other programs (applications). Software applications 108 such as program modules and performance management application 120 are examples of programs or program modules that may be executed under the control of operating system 106 in system memory 104. Additional operating systems or programs may also be executed within system memory 104 outside the control of operating system 106. Performance management application 120 may coordinate tracking of work activities, maintain reports, schedule future activities, and the like.

According to some embodiments, performance management application 120 may include one or more modules responsible to individual tasks in managing performance related activities. One such module may be tracking utility 122. Tracking utility 122 may perform tasks such as monitoring work activities based on inputs from employees and/or managers, preparing and providing reports to higher level managers, other applications, and the like. Tracking utility 122 may be an integrated part of the performance management application 120 or a separate application. Tracking utility 122 and performance management application 120 may communicate with other applications running on computing device 100 or on other devices. Furthermore, performance management application 120 may be executed in an operating system other than operating system 106.

The computing device 100 may have additional features or functionality. For example, the computing device 100 may also include data storage devices 110 (removable and/or non-removable) such as, for example, magnetic disks, optical disks, or tape. Computer storage media may include volatile and nonvolatile, removable and non-removable media implemented in any method or technology for storage of information, such as computer readable instructions, data structures, program modules, or other data. System memory 104 and storage devices 110 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100.

Computing device 100 may also include input device(s) 112 such as a keyboard, a mouse, a pen, a voice input device, a touch input device, etc. Furthermore, output device(s) 114 such as a display, a speaker, a printer, etc. may also be included. These devices are well known in the art.

Communication connections 116 may be included in computing device 100 to allow the device to communicate with other computing devices 118, such as over a network in a distributed computing environment, for example, an intranet or the Internet. Communication connection 116 exemplifies various communication media. Communication media may be embodied by computer readable instructions, data structures, program modules, or other data in a modulated data signal, such as a carrier wave or other transport mechanism, and include any information delivery media.

By way of example, and not limitation, communication media may include wired media such as a wired network or direct-wired connection, and wireless media such as acoustic, RF, infrared and other wireless media. The term computer readable media as used herein refers to both storage media and communication media.

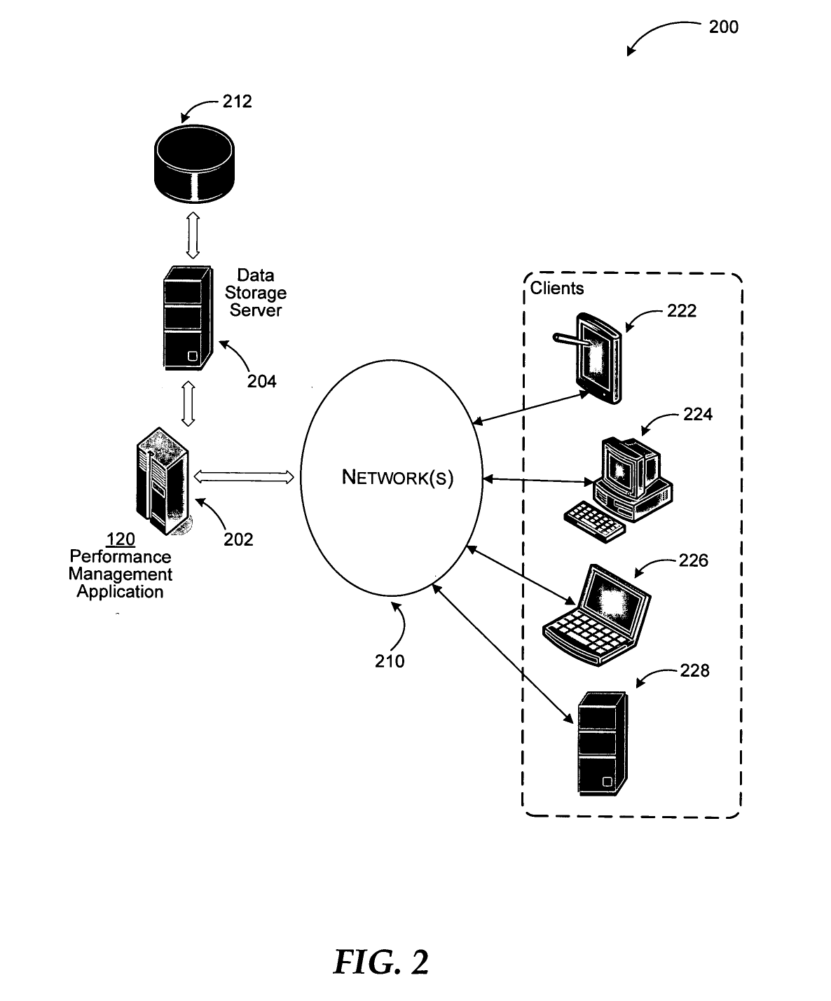

Referring to FIG. 2, a system 200 where example embodiments may be implemented, is illustrated. System 200 may comprise any topology of servers, clients, Internet service providers, and communication media. Also, system 200 may have a static or dynamic topology. The term “client” may refer to a client application or a client device employed by a user to perform business logic operations. Performance management application 120 may be one or more programs or a server machine executing programs associated with the server tasks. Both clients and application servers may be embodied as single device (or program) or a number of devices (programs). Similarly, data sources may include one or more data stores, input devices, and the like.

The performance management application 120 and tracking utility 122 may be run centrally on server 202 or in a distributed manner over several servers and/or client devices. Performance management application 120 may include implementation of a number of organizational management systems such as time tracking, performance evaluation, activity scheduling, and the like. A number of other applications may also be configured, deployed, and shared in system 200. In addition, the performance management application 120 may also be run in one or more client devices and information exchanged over network(s) 210.

Data store 212 is an example of a number of data stores that may be utilized to store data associated with activity tracking. Data store 212 may be managed by data storage server 204 or directly accessed by server 202 or any one of the clients.

Users such as employees, managers, and administrators may interact with server 202 running the performance management application 120 from client devices 222, 224, 226, and 228 over network(s) 210. In one embodiment, portions or all of the performance management application 120 may reside on any one of the client devices 222, 224, 226, and 228. In such an embodiment, data may be stored in data store 212 without an involvement of server 202.

According to some embodiments, users may be provided one or more UIs to enter activity data such as activity type, time, exceptions, and the like. Other users, such as supervising managers, may receive reports prepared by performance management application 120.

Network(s) 210 may include a secure network such as an enterprise network, or an unsecure network such as a wireless open network. Network(s) 210 provide communication between the nodes described above. By way of example, and not limitation, network(s) 210 may include wired media such as a wired network or direct-wired connection, and wireless media such as acoustic, RF, infrared and other wireless media. Many other configurations of computing devices, applications, and data storage may be employed to implement a performance management system with activity tracking.

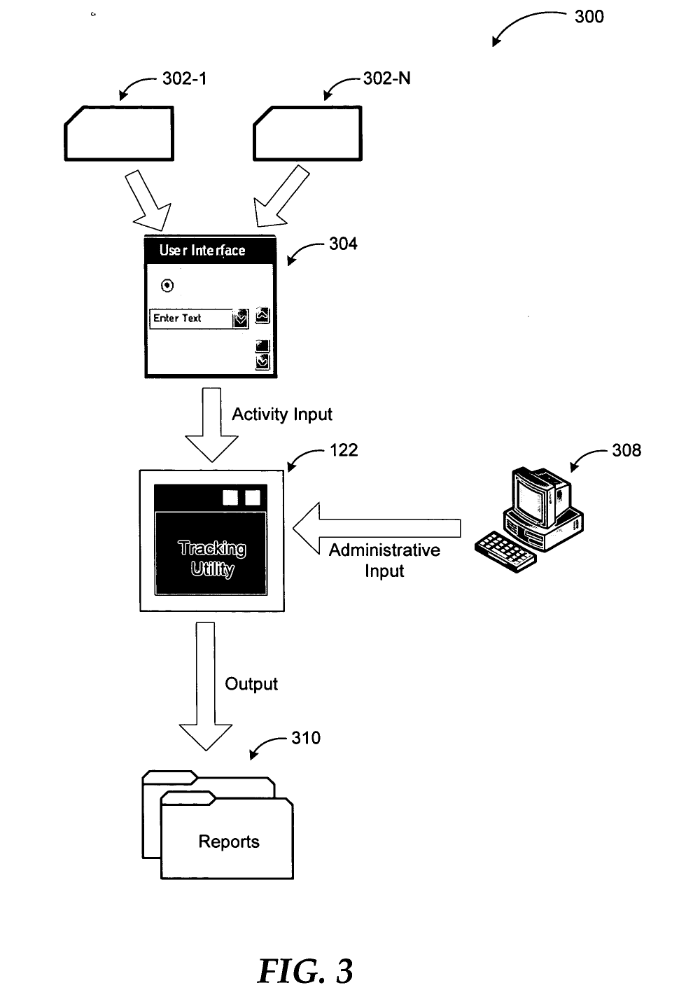

Now referring to FIG. 3, conceptual diagram 300 of interactions between components of the system 200 is illustrated. The system 200 according to embodiments may comprise any topology of processing systems, storage systems, source systems, and configuration systems.

At the core of the system 200 is tracking utility 122 that is configured to receive input associated with activities, receive configuration information associated with activities and employees whose activities are being tracked, and prepare reports based on the received information.

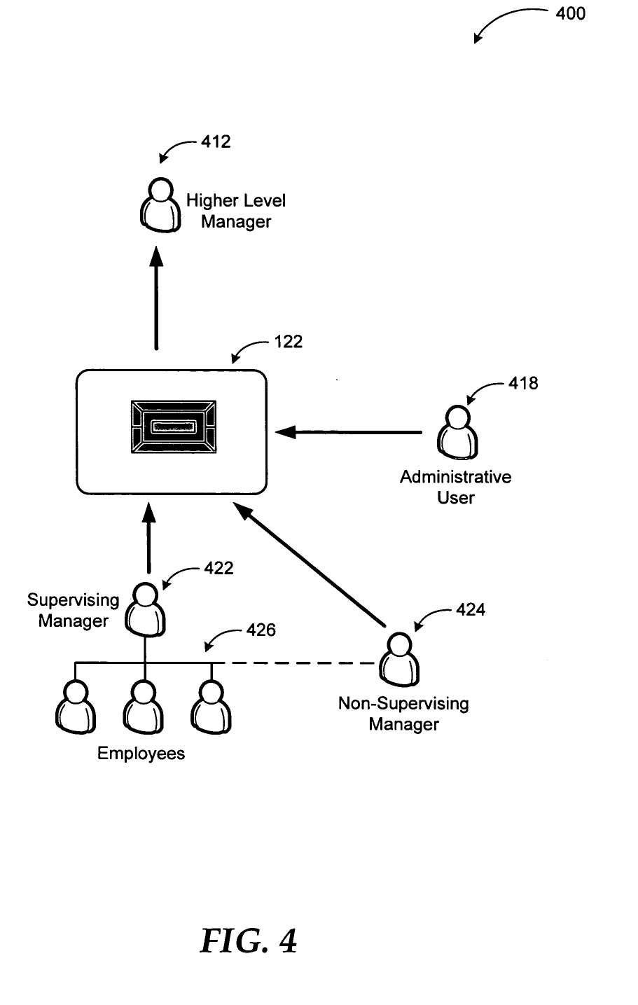

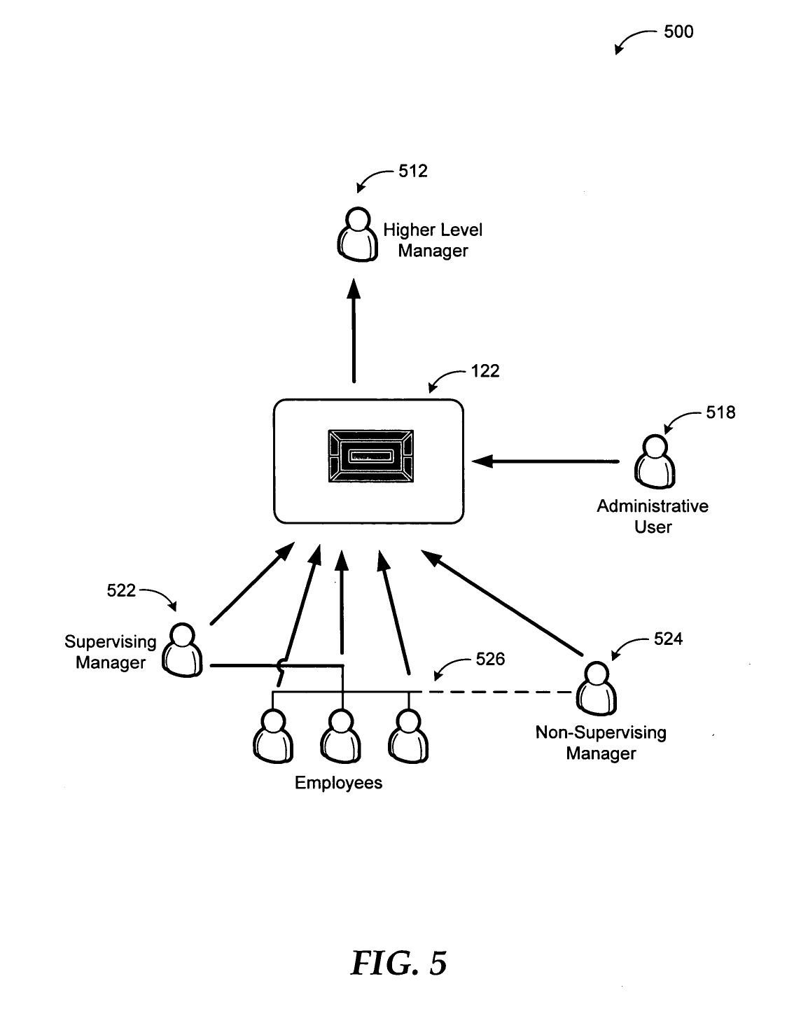

Input associated with activities, e,g, inputs 302-1 through 302-N, may be entered through user interface 304. As explained below in conjunction with FIGS. 4 and 5, employees themselves may provide the input, or managers may provide the input for the employees reporting to them. In a multi-layered hierarchical organization, any level of organization members may provide input associated with their activities into the system 200. The input may include a description and/or type of activity, time and duration of the activity, and any additional information associated with the activity such as exceptions.

User interface 304 may be configured to enable the users to enter their input information in any way known in the art. For example, a graphical user interface (GUI) may be used for efficient and user friendly entry of information. According to some embodiments, user interface 304 may be an integral part of tracking utility program 306 or a component of another application such as a calendar application that communicates with tracking utility 122.

Another input to tracking utility 122 may be provided by administrative users 308 for configuring employee and/or activity information, or other parameters associated with tracking utility 122. Examples of administrative information include, but are not limited to, employee personal information, activity types, input entry restrictions, report types that can be generated, schedule of report generation, and the like. Administrative users 308 may be separate personnel or managers with predefined permission levels.

Tracking utility 122 may provide its output in the form of reports 310 based on the activity input and receive configuration information. The reports 310 may include any form of activity presentation such as charts, histograms, diagrams, and the like. According to other embodiments, the reports 310 may also include raw or formatted data that can be consumed by other applications such as statistical analysis applications, scheduling applications, and the like. The reports 310 may be provided on demand, periodically, and the like.

According to further embodiments, providing input (activity or configuration) to or receiving output from tracking utility 122 may be associated with user credentials. For example, providing input may be based on a permission level of an employee (or manager). Permission levels may determine whether a user can provide any input at all or whether the user can provide certain portions of activity input. According to another example, a permission level may authorize an employee to select from predefined activity types only, while another permission level may authorize an employee to define their own activity type(s). Similarly, who may receive what types of reports may also be based on a permission level of the recipient manager.

Tracking utility 122 may be any application such as an executable computer program, a web application, and the like. The examples provided above are for illustration purposes only. Individual components of an activity tracking system may be implemented in any way using the principles described herein.

FIG. 4 illustrates a conceptual diagram of how the tracking utility 122 can be used according to one scenario. Conceptual diagram 400 includes tracking utility 122 and different users that interact with the tracking utility 122 through system 200 of FIG. 2. According to one scenario, employees 426 report to supervising manager 422, who provides activity input for employees 426 to tracking utility 122.

In one embodiment, employees 426 may also perform tasks that are associated with non-supervising manager 424. Non-supervising manager 424 may also provide input for activities performed by the employees associated with him/her.

Administrative user 418 may provide configuration information as described previously. Administrative user 418 may be an organization member designated for configuration tasks (e.g. human resources personnel) or some of the managers 422 or 424. According to some embodiments, the employees 426 themselves may even be designated as administrative user e.g. to modify configuration associated with their own personal information.

Higher level manager 412 represents any user that is authorized to receive reports prepared by tracking utility 122 based on the received information. As suggested by the name, higher level manager 412 may be an organization member at a higher hierarchy level or one of the managers providing activity input. The reports 310 may be prepared real time or in an accrued mode at individual member level, at group level, or any combination thereof.

FIG. 5 illustrates a conceptual diagram of how the tracking utility 122 can be used according to another scenario. Conceptual diagram 500 includes similar components as described above for conceptual diagram 400 of FIG. 4.

Differently from FIG. 4, the input providing structure of system 200 of FIG. 5 includes employees 526 providing their individual activity information in addition to input provided by supervising manager 522 and non-supervising manager 524. Higher level manager 512 and administrative user 518 are as described previously with higher level manager 412 and administrative user 418, respectively. According to some embodiments, individual employees 526 may have different permission levels resulting in varying input entry restrictions.

The scenarios and systems described in FIGS. 4 and 5 are for illustration purposes only and do not constitute a limitation on embodiments. Other configurations of a tracking utility system may be implemented without departing from a scope and spirit of the present invention.

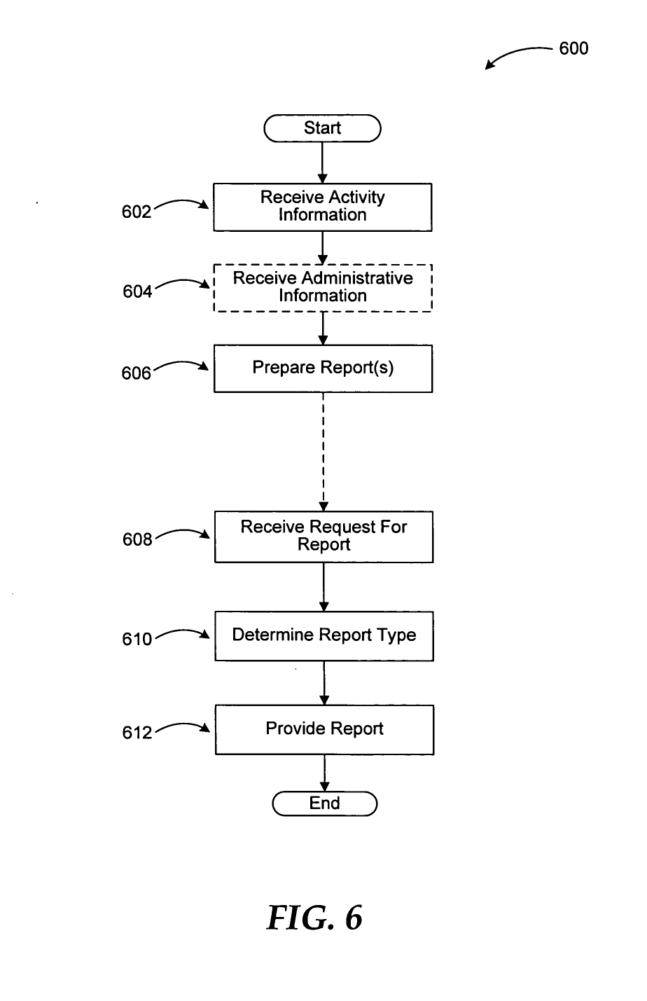

FIG. 6 illustrates a logic flow diagram for a process 600 of tracking work activities according to one embodiment. Process 600 may be implemented in the performance management application 120.

Process 600 begins with operation 602, where the tracking utility 122 receives activity information from a manager or reporting employee. The activity information may include activity type, description, time and/or duration of the activity, and any other information associated with the activity such as exceptions. Processing moves from operation 602 to optional operation 604.

At optional operation 604, the tracking utility 122 receives administrative information. Administrative information may include any information associated with configuring the tracking utility program, such as employee personal information, available activity types, report preparation schedule, group structures for group reports, and the like. Processing advances from optional operation 604 to operation 606.

At operation 606, the tracking utility 122 prepares one or more reports based on the received information. According to some embodiments, reports may be prepared in real time mode and made available to recipients. According to other embodiments, reports may be prepared on demand at the time of request.

As illustrated by the dashed progress line, processing by the performance management application 120 may proceed from operation 606 to operation 608, where the tracking utility 122 receives a request for a report 310. Permission levels may be utilized to restrict who can request a report 310 from the system 200 or what type of report(s) 310 may be requested. Processing moves from operation 608 to operation 610.

At operation 610, the tracking utility 122 determines the requested report type. Report types may include reports for individual activity reporters, reports for groups of employees, and the like. Report types may also include presentation types such as charts, diagrams, histograms, raw data, formatted data, and the like. Processing advances from operation 610 to operation 612.

At operation 612, the tracking utility 122 provides the requested report(s) 310 to the requesting user or application. After operation 610, processing within the performance management application 120 moves to a calling process for further actions.

The operations included in process 600 are for illustration purposes. Tracking work activities, exceptions, and lost time by supervising and non-supervising managers may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for tracking work activity, comprising:
receiving information associated with a work activity for a reporting member of an organization;
preparing a plurality of reports based on the received work activity information;
receiving a request for a report;
) determining a requested report type; and
providing the report in response to the request and the determined report type.

2. The method of claim 1, further comprising:
receiving configuration information associated with tracking work activity.

3. The method of claim 2, wherein the configuration information includes at least one from a set of: an activity type, personal information associated with the organization member, available report types, a report preparation schedule, and a permission level associated with a report recipient.

4. The method of claim 2, wherein the configuration information is received from at least one of: an administrative member, the reporting member, and a report receiving member of the organization.

5. The method of claim 3, wherein the report preparation schedule is one of: on demand and based on a predefined period.

6. The method of claim 1, wherein the report type includes at least one from a set of: a chart, a diagram, a histogram, raw data, and formatted data.

7. The method of claim 1, wherein the report is provided to one of a report receiving organization member and an application.

8. The method of claim 7, wherein the application includes at least one of an analysis application, a scheduling application, a presentation application, and a performance evaluation application.

9. The method of claim 1, wherein at least a portion of the information associated with the work activity is accepted based on a permission level of the reporting organization member.

10. The method of claim 1, wherein report is provided based on a permission level of a report receiving organization member.

11. The method of claim 1, wherein the information associated with the work activity includes at least one from a set of: an activity type, an activity description, a time of the activity, a duration of the activity, a property associated with the activity.

12. The method of claim 11, wherein the property associated with the activity includes an exception.

13. A computer-readable medium having computer executable instructions for tracking work activity, the instructions comprising:
receiving information associated with a work activity from one of an employee and a first manager;
preparing at least one report based on the received work activity information;
receiving a request for a report from a second manager;
determining a requested report type; and
providing the report to the second manager in response to the request and the determined report type.

14. The computer-readable medium of claim 13, wherein the instructions further comprise:
receiving configuration information associated with tracking the work activity from an administrative user.

15. The computer-readable medium of claim 14, wherein the first manager, the second manager, and the administrative user are the same.

16. The computer-readable medium of claim 13, wherein the instructions further comprise:
providing one of raw data and formatted data associated with the prepared report to at least one of: an analysis application, a scheduling application, a presentation application, and a performance evaluation application.

17. The computer-readable medium of claim 14, wherein the instructions further comprise:
accepting at least a portion of the configuration information based on a permission level of the administrative user.

18. A system for tracking employee activities, comprising:
an input user interface (UI) module configured to:
receive information associated with a work activity for an employee;
a tracking application arranged to:
prepare a plurality of reports based on the received work activity information;
receive configuration information associated with tracking the work activity from an administrative user;
receive a request for a report from a manager;
determine a requested report type; and
an output user interface (UI) module arranged to:
provide at least one of the plurality of prepared reports to a requesting manager based on the manager's permission level.

19. The system of claim 18, wherein the input UI module is further arranged to receive the information from one of the employee, a supervising manager, and a non-supervising manager.

20. The system of claim 18, wherein the output UI module is further arranged to provide data associated with the at least one of the plurality of prepared reports to an application.
